(19) United States
(12) Patent Application Publication
(10) Pub. No.: US 2024/0336143 A1
(43) Pub. Date: Oct. 10, 2024

(54) High-voltage component of an electric vehicle

(71) Applicant: Dr. Ing. h.c.F. Porsche Aktiengesellschaft, Stuttgart (DE)

(72) Inventor: Phillip Müller, Stuttgart (DE)

(73) Assignee: Dr. Ing. h.c.F. Porsche Aktiengesellschaft, Stuttgart (DE)

(21) Appl. No.: 18/623,178

(22) Filed: Apr. 1, 2024

(30) Foreign Application Priority Data
Apr. 4, 2023 (DE) 102023108590.5

(51) Int. Cl. B60L 3/00; B60L 1/00; B60L 15/00; H02K 7/14; H02K 11/33

(52) U.S. Cl. CPC B60L 3/0061; B60L 1/003; B60L 15/007; H02K 7/14; H02K 11/33; B60L 2210/10

(57) ABSTRACT

A high-voltage component of an electric vehicle, which high-voltage component can be connected to a high-voltage traction battery of the electric vehicle. The high-voltage component includes at least one electric machine; a power electronic assembly which is configured to convert the high voltage of the traction battery into an operating voltage for the electric machine; and a control assembly which can be connected to a low-voltage on-board electrical system of the electric vehicle. The control assembly includes a control unit which is configured to control the operation of the high-voltage component. The power electronic assembly has an integrated DC-DC voltage converter which is connected to the control assembly and which is designed to convert the high voltage of the traction battery into a voltage corresponding to the voltage of the low-voltage on-board electrical system of the electric vehicle.

### CROSS-REFERENCE TO RELATED APPLICATION

This application claims priority to German Patent Application No. 10 2023 108 590.5, filed Apr. 4, 2023, the content of such application being incorporated by reference herein in its entirety.

### FIELD OF THE INVENTION

The present invention relates to a high-voltage component of an electric vehicle, which high-voltage component can be connected to a high-voltage traction battery of the electric vehicle, comprising at least one electric machine, a power electronic assembly which is configured to convert the high voltage of the traction battery into an operating voltage for the electric machine, and a control assembly which can be connected to a low-voltage on-board electrical system of the electric vehicle and comprises a control unit which is configured to control the operation of the high-voltage component.

### BACKGROUND OF THE INVENTION

The term “electric vehicle” in the context of the present application refers to both pure battery-electric vehicles, which have only one or more electric machines as drive devices, and hybrid-electric vehicles, in which, in addition to an electric machine, a conventional internal combustion engine is also used as drive device.

High-voltage components of an electric vehicle of the type mentioned in the background are known from the prior art in different embodiments. During operation, the power electronic assembly is used to convert the high voltage of the traction battery of the electric vehicle, such as a voltage of 800 V (DC) for example, into an operating voltage for the electric machine. Since the synchronous and asynchronous motors commonly used in electric vehicles are usually operated using AC voltage, power electronic assemblies have at least one inverter which is designed to convert the high voltage of the traction battery into the AC operating voltage of the electric machine. In general, electric machines in electric vehicles can also be used for other purposes and therefore not only for drive purposes.

The control assembly with the control unit, which can be used to control the operation of the high-voltage component, is connected to a low-voltage on-board electrical system of the electric vehicle. The voltage of the low-voltage on-board electrical system of the electric vehicle is much lower than the voltage of the traction battery that feeds the electric machine. For example, the voltage of the low-voltage on-board electrical system of the electric vehicle may be 12 V (DC) or 48 V (DC). Other low-voltage on-board electrical system voltages are generally also conceivable.

In the case of the high-voltage components known from the prior art, there is the problem in particular that safety functions, which are triggered by the control unit in the event of a fault or in a crash, are no longer available in the event of a failure of the low-voltage on-board electrical system. This has a negative effect on the operational safety of such high-voltage components.

### SUMMARY OF THE INVENTION

Described herein is a high-voltage component of the type mentioned in the background that is configured in such a way that higher operational safety is provided.

A high-voltage component of an electric vehicle is characterized in that the power electronic assembly has an integrated DC-DC voltage converter which is connected to the control assembly and which is designed to convert the high voltage of the traction battery into a voltage corresponding to the voltage of the low-voltage on-board electrical system of the electric vehicle. This measure is used to provide a redundant voltage supply for the control assembly, in particular for the control unit of the control assembly. In the event of a failure of the low-voltage on-board electrical system of the electric vehicle, the control assembly can continue to be supplied with an electrical operating voltage such that the control unit can continue to trigger appropriate safety functions. As a result, higher operational safety of the high-voltage component can advantageously be achieved, in particular in the event of a fault or in a crash.

In one embodiment, it is proposed that the high-voltage component has at least one pump device which is connected to the electric machine. The pump device can preferably be embodied as a hydraulic internal gear pump.

In order to improve the electromagnetic compatibility of the high-voltage component, in one embodiment there is the possibility that the power electronic assembly has an EMI filter means. The EMI filter means may be designed, for example, as an EMI filter reactor.

In one embodiment, it is proposed that the power electronic assembly has a circuit breaker by means of which the electric machine is connected to the power electronic assembly. The circuit breaker can preferably be used as an insulated-gate bipolar transistor (abbreviated to IGBT for short).

In one embodiment, there is the possibility that the power electronic assembly has a converter DC link with a DC link capacitor arrangement.

In one advantageous embodiment, provision is made for the control unit to be designed to initiate an active electrical discharge of the high-voltage component in the event of a fault or crash. In particular, the capacitors of the DC link capacitor arrangement can be discharged in this case.

In one further advantageous embodiment, there is the possibility that the control unit is designed to initiate an active phase short-circuit of the electric machine in the event of a fault or crash. The electric machine is then stationary and the pump device, which is designed in particular as an internal gear pump, no longer rotates. The pump device can then advantageously also no longer induce an electrical voltage during a movement of the body of the electric vehicle.

If, for example, the low-voltage on-board electrical system of the electric vehicle should fail in the event of a fault or a crash, the necessary safety measures, such as the active electrical discharge of the high-voltage component and/or the active initiation of a phase short-circuit of the electric machine for example, can still be initiated by the control unit on account of the redundant voltage supply, which results in a high safety level of the high-voltage component.

In one embodiment, the high-voltage component presented here may, for example, be part of an active damping regulation apparatus of the electric vehicle.

### BRIEF DESCRIPTION OF THE DRAWING

Further features and advantages of the present invention will become clear based on the following description of a preferred embodiment with reference to the enclosed FIGURE.

FIG. 1 shows a perspective view of a high-voltage component of an electric vehicle.

### DETAILED DESCRIPTION OF THE INVENTION

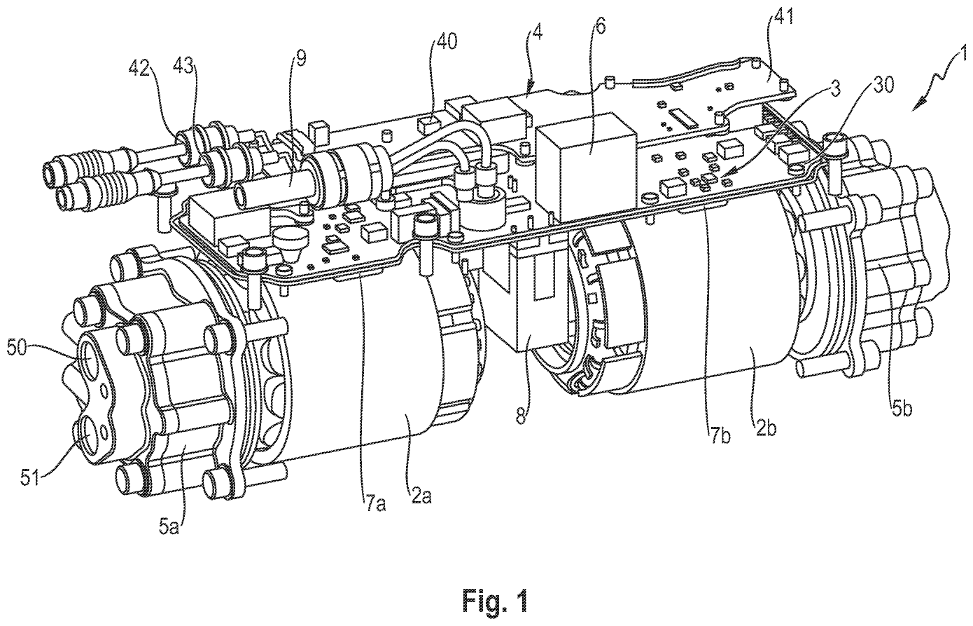

FIG. 1 shows a perspective view of a high-voltage component 1 of an electric vehicle. The high-voltage component 1 in this exemplary embodiment is part of an active damping regulation apparatus of the electric vehicle.

In this exemplary embodiment, the high-voltage component 1 comprises a first electric machine 2a and a second electric machine 2b. A respective pump device 5a, 5b is connected to each of the two electric machines 2a, 2b. The pump devices 5a, 5b are formed in this exemplary embodiment as hydraulic internal gear pumps, each having two hydraulic connections 50, 51 for connection to a hydraulic circuit.

The high-voltage component 1 further comprises a power electronic assembly 3 which is realized on a power board 30 and which is configured to convert the high voltage of the traction battery of the electric vehicle, for example an electrical voltage of 800 V (DC), into an operating voltage for the two electric machines 2a, 2b. The high voltage may vary and may be 800 V (DC)+/−400 V, by way of non-limiting example. The traction battery is connected to the power electronic assembly 3 via a high-voltage connection means 9. For the purpose of voltage conversion, the power electronic assembly 3 has suitably designed converter means. The two electric machines 2a, 2b may be designed, for example, as synchronous or asynchronous motors, which are usually operated using AC voltage. The converter means of the power electronic assembly 3 then have at least one inverter which is designed to convert the high voltage of the traction battery into the AC operating voltage of the electric machines 2a, 2b. In this exemplary embodiment, the power electronic assembly 3 comprises a converter DC link with a DC link capacitor arrangement 8.

The power electronic assembly 3 further comprises two circuit breakers 7a, 7b by means of which the two electric machines 2a, 2b are connected to the power electronic assembly 3. The circuit breakers 7a, 7b may, for example, each be designed as an insulated-gate bipolar transistor. Such insulated-gate bipolar transistors (abbreviated to IGBT for short) are characterized in particular by high voltage and current limits. In order to improve the electromagnetic compatibility of the power electronic assembly 3, the power electronic assembly 3 also has an EMI filter means 6 which may be designed in particular as an EMI filter reactor.

In addition, the high-voltage component 1 comprises a control assembly 4 which can be connected to a low-voltage on-board electrical system of the electric vehicle and comprises a control unit 40 which is configured to control the operation of the high-voltage component 1. The control assembly 4 is realized on a control board 41 and connected to a CAN bus system of the electric vehicle by means of a CAN bus connection 42.

The voltage of the low-voltage on-board electrical system of the electric vehicle is much lower than the high voltage of the traction battery. For example, the voltage of the low-voltage on-board electrical system may be 12 V or 48 V. Other voltage values of the low-voltage on-board electrical system are also possible in principle. The control unit 40 is also configured to trigger appropriate safety functions in the event of a fault or in a crash. Since the active damping regulation apparatus of the electric vehicle, which apparatus comprises the high-voltage component 1, is very exposed due to its installation position at the bottom of the vehicle floor and is therefore particularly vulnerable in the event of a crash.

In the event of a failure of the low-voltage on-board electrical system, the control unit 40 is no longer capable of triggering corresponding safety functions in the high-voltage components 1 known from the prior art. To address this problem, the power electronic assembly 3 has an integrated DC-DC voltage converter which is connected to the control assembly 4 and which is designed to convert the high voltage of the traction battery into a voltage corresponding to the voltage of the low-voltage on-board electrical system of the electric vehicle. This measure is used to provide a redundant voltage supply for the control assembly 4, in particular for the control unit 40 of the control assembly 4.

In the event of a failure of the low-voltage on-board electrical system of the electric vehicle, the control assembly 4 can continue to be supplied with the required electrical operating voltage such that the control unit 40 can continue to trigger appropriate safety functions in the event of a fault or in a crash. The redundant voltage supply of the control assembly 4 can therefore advantageously be used to achieve higher operational safety of the high-voltage component 1, in particular in the event of a fault or in a crash.

The control unit 40 may, for example, be designed to initiate an active electrical discharge of the high-voltage component 1 in the event of a fault or crash. In particular, the capacitors of the DC link capacitor arrangement 8 can be discharged in this case.

Furthermore, the control unit 40 may be designed to initiate an active phase short-circuit of the two electric machines 2a, 2b in the event of a fault or crash. The two electric machines 2a, 2b are then stationary and the two pump devices 5a, 5b, which can be driven thereby and in the present case are designed as internal gear pumps, no longer rotate. The pump devices 5a, 5b can then advantageously no longer induce an electrical voltage during a movement of the body of the electric vehicle.

What is claimed is:

1. A high-voltage component of an electric vehicle, wherein the high-voltage component is configured to be connected to a high-voltage traction battery of the electric vehicle, said high-voltage component comprising:
at least one electric machine;
a power electronic assembly which is configured to convert a high voltage of the traction battery into an operating voltage for the electric machine; and
a control assembly which is configured to be connected to a low-voltage on-board electrical system of the electric vehicle and comprises a control unit which is configured to control operation of the high-voltage component,
wherein the power electronic assembly has an integrated DC-DC voltage converter which is connected to the control assembly and which is configured to convert the high voltage of the traction battery into a voltage corresponding to the voltage of the low-voltage on-board electrical system of the electric vehicle.

2. The high-voltage component as claimed in claim 1, wherein the high-voltage component has at least one pump device which is connected to the electric machine.

3. The high-voltage component as claimed in claim 2, wherein the pump device is a hydraulic internal gear pump.

4. The high-voltage component as claimed in claim 1, wherein the power electronic assembly has an EMI filter.

5. The high-voltage component as claimed in claim 1, wherein the power electronic assembly has a circuit breaker by way of which the electric machine is connected to the power electronic assembly.

6. The high-voltage component as claimed in claim 5, wherein the circuit breaker is an insulated-gate bipolar transistor.

7. The high-voltage component as claimed in claim 1, wherein the power electronic assembly has a converter DC link with a DC link capacitor arrangement.

8. The high-voltage component as claimed in claim 1, wherein the control unit is configured to initiate an active electrical discharge of the high-voltage component in the event of a fault or crash.

9. The high-voltage component as claimed in claim 1, wherein the control unit is configured to initiate an active phase short-circuit of the electric machine in the event of a fault or crash.

10. The high-voltage component as claimed in claim 1, wherein the high-voltage component forms part of an active damping regulation apparatus of the electric vehicle.

11. An electric vehicle comprising the high-voltage component of claim 1.
